(19) United States
(12) Patent Application Publication
(10) Pub. No.: US 2026/0065144 A1
(43) Pub. Date: Mar. 5, 2026

(54) METHOD AND APPARATUS FOR GENERATING MODEL

(71) Applicant: BEIJING XIAOMI MOBILE SOFTWARE CO., LTD., Beijing (CN)

(72) Inventors: Qin MU, Beijing (CN); Song LI, Beijing (CN)

(73) Assignee: BEIJING XIAOMI MOBILE SOFTWARE CO., LTD., Beijing (CN)

(21) Appl. No.: 18/994,195

(22) PCT Filed: Jul. 25, 2022
(86) PCT No.: PCT/CN2022/107706

§ 371 Date: Jan. 14, 2025

(51) Int. Cl. G06N 20/00

(52) U.S. Cl. CPC G06N 20/00

(57) ABSTRACT

A method for generating a model, performed by a first device, includes: obtaining a pre-trained model; receiving model calibration auxiliary information sent by a second device; generating a calibrated model by performing calibration on the pre-trained model based on the model calibration auxiliary information; and sending the calibrated model to the second device.

### CROSS-REFERENCE TO RELATED APPLICATION

This application is a U.S. national phase of International Application No. PCT/CN2022/107706, filed Jul. 25, 2022, the entire content of which is incorporated herein by reference.

### TECHNICAL FIELD

The disclosure relates to a field of wireless communication technologies, in particular to a method and an apparatus for generating a model.

### BACKGROUND

Artificial intelligence (AI) is gradually applied to a communication system, to assist in improving the efficiency of a communication algorithm. Training an AI model in the communication system may need the participation of all parties to maximize the accuracy of the AI model. For example, beam management needs beam configuration data from a network device side and feedback information from a terminal side. Thus, how to generate and arrange the AI model in the communication system becomes a problem to be solved currently.

### SUMMARY

In a first aspect, an embodiment of the disclosure provides a method for generating a model. The method is performed by a first device, including: obtaining a pre-trained model; receiving model calibration auxiliary information sent by a second device; and performing calibration on the pre-trained model based on the model calibration auxiliary information.

In a second aspect, an embodiment of the disclosure provides a method for generating a model. The method is performed by a second device, including: sending model calibration auxiliary information to a first device; and receiving a calibrated model subjected to calibration based on the model calibration auxiliary information sent by the first device.

In a third aspect, an embodiment of the disclosure provides a first device. The first device includes: a processor and a memory for storing a computer program. The processor is configured to execute the computer program, to cause the first device to execute the method in the first aspect above.

In a fourth aspect, an embodiment of the disclosure provides a second device. The second device includes: a processor and a memory for storing a computer program. When the processor is configured to execute the computer program, to cause the second device to execute the method in the second aspect above.

### BRIEF DESCRIPTION OF THE DRAWINGS

In order to clearly illustrate a technical solution in embodiments of the disclosure or the related art, description is made below to accompanying drawings used in embodiments of the disclosure or the related art.

FIG. 1 is a schematic diagram illustrating a communication system according to an embodiment of the disclosure.

FIG. 2 is a flow chart illustrating a method for generating a model according to an embodiment of the disclosure.

FIG. 3 is a flow chart illustrating a method for generating a model according to another embodiment of the disclosure.

FIG. 4 is a flow chart illustrating a method for generating a model according to another embodiment of the disclosure.

FIG. 5 is a flow chart illustrating a method for generating a model according to another embodiment of the disclosure.

FIG. 6 is a flow chart illustrating a method for generating a model according to another embodiment of the disclosure.

FIG. 7 is a flow chart illustrating a method for generating a model according to a still another embodiment of the disclosure.

FIG. 8 is a flow chart illustrating a method for generating a model according to a still another embodiment of the disclosure.

FIG. 9 is a flow chart illustrating another method for generating a model according to a still another embodiment of the disclosure.

FIG. 10 is a schematic diagram illustrating interaction of a method for generating a model according to a still yet embodiment of the disclosure.

FIG. 11 is a schematic diagram illustrating interaction of a method for generating a model according to another embodiment of the disclosure.

FIG. 12 is a schematic diagram illustrating interaction of a method for generating a model according to a still another embodiment of the disclosure.

FIG. 13 is a block diagram illustrating a communication device according to an embodiment of the disclosure.

FIG. 14 is a block diagram illustrating a communication device according to another embodiment of the disclosure.

FIG. 15 is a block diagram illustrating a chip according to an embodiment of the disclosure.

### DETAILED DESCRIPTION

In order to better understand a method for generating a model according to embodiments of the disclosure, firstly, description is made below to a communication system to which embodiments of the disclosure are applicable.

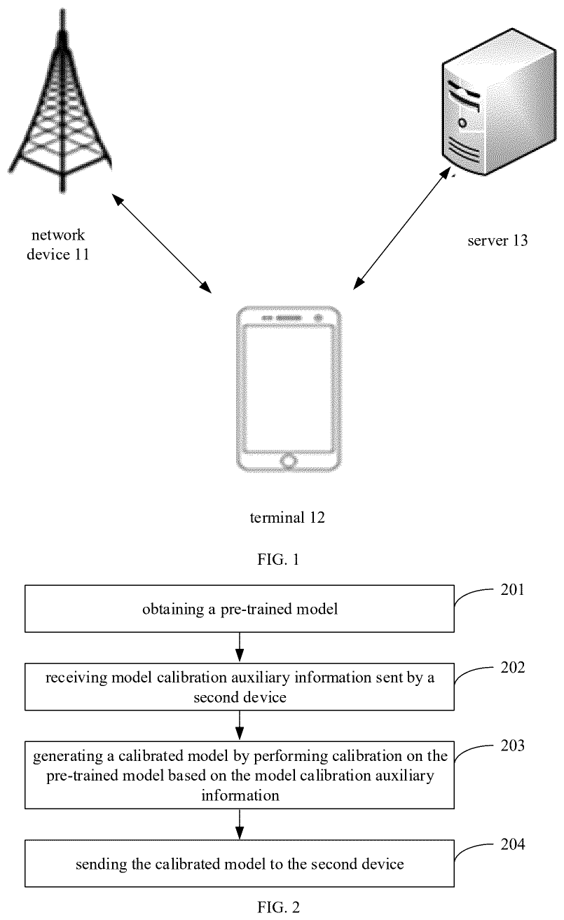

Referring to FIG. 1, FIG. 1 is a schematic diagram illustrating a communication system according to an embodiment of the disclosure. The communication system may include, but is not limited to, a network device, a terminal and a server. The number and form of devices illustrated in FIG. 1 are only for examples and do not constitute a limitation on embodiments of the disclosure, and two or more network devices and two or more terminals may be included in a practical application. For example, the communication system illustrated in FIG. 1 includes a network device 11, a terminal 12 and a server 13.

It should be noted that an technical solution of embodiments of the disclosure may be applied to various communication systems, such as a long term evolution (LTE) system, a fifth generation (5G) mobile communication system, a 5G new radio (NR) system, or other future new mobile communication systems.

The network device 11 in embodiments of the disclosure is an entity in a network side for transmitting or receiving a signal. For example, the network device 101 may be an evolved NodeB (eNB), a transmission reception point (TRP), a next generation NodeB (gNB) in an NR system, a base station in other future mobile communication systems or an access node in a wireless fidelity (WiFi) system, etc. The detailed technology and detailed device form employed by the network device are not limited in embodiments of the disclosure. The network device in embodiments of the disclosure may be combined by a central unit (CU) and a distributed unit (DU). The CU may also be referred to as a control unit. The CU-DU structure may be configured to split a protocol layer of the network device, such as the base station, in which, some of functions of the protocol layer are centrally controlled by the CU, while some or all of remaining functions of the protocol layer are distributed in the DU which is controlled by the CU.

The terminal 12 in embodiments of the disclosure is an entity in a user side for receiving or transmitting a signal, such as a mobile phone. The terminal may also be referred to as a terminal device, a user equipment (UE), a mobile station (MS), a mobile terminal (MT), and the like. The terminal may be an automobile with a communication function, a smart automobile, a mobile phone, a wearable device, a pad, a computer with a wireless receiving and sending function, a virtual reality (VR) terminal, an augmented reality (AR) terminal, a wireless terminal in industrial control, a wireless terminal in self-driving, a wireless terminal in a remote medical surgery, a wireless terminal in a smart grid, a wireless terminal in a transportation safety, a wireless terminal in a smart city, a wireless terminal in a smart home, and the like. Detailed technologies and detailed device forms employed by the terminal are not limited in embodiments of the disclosure.

The server 13 is a device with a data processing capability, and may be configured to perform data processing and storage and to communicate with the terminal 12.

It may be understood that the communication system described in embodiments of the disclosure is intended to more clearly illustrate the technical solution of embodiments of the disclosure, and does not constitute a limitation on the technical solution according to embodiments of the disclosure. Those skilled in the art understand that the technical solution according to embodiments of the disclosure are also applicable to similar technical problems, with the evolution of system architecture and the emergence of a new service scenario.

Referring to FIG. 2, FIG. 2 is a flow chart illustrating a method for generating a model according to an embodiment of the disclosure. The method is performed by a first device. As illustrated in FIG. 2, the method may include, but is not limited to, the following.

At step 201, a pre-trained model is obtained.

Alternatively, the first device may be a network device, a terminal, or a server, which is not limited in the disclosure.

The pre-trained model is an initial model generated by the first device performing pre-training based on training data. Alternatively, the pre-trained model may be an initial model received by the first device, which is generated by the second device performing pre-training based on training data.

At step 202, model calibration auxiliary information sent by a second device is received.

At step 203, a calibrated model is generated by performing calibration on the pre-trained model based on the model calibration auxiliary information.

The model calibration auxiliary information is auxiliary information for calibrating the pre-trained model determined by the second device, or auxiliary information for calibrating the pre-trained model received by the second device from another device.

In the disclosure, in order to ensure an obtained final model, information of each device is considered. The pre-trained model may be firstly generated by performing training based on basic training data, and then the pre-trained model is calibrated based on training data (the calibration auxiliary information) provided by each device.

Alternatively, if the first device is a network device, the second device may be a terminal. That is, after the network device generates the pre-trained model subjected to training, the terminal may send the model calibration auxiliary information corresponding to the terminal itself to the network device. For example, for a model used for beam management, the terminal may send feedback information and the like of a beam which the terminal measures and determines to the network device. Alternatively, in the case that the model is configured to encode and decode certain parameters, such as a model for encoding and decoding channel state information (CSI) feedback information, the terminal may send the CSI feedback information which the terminal measures and determines to the network device.

Alternatively, if the first device is a terminal, the second device may be a network device. In this case, the model calibration auxiliary information sent by the network device may be a processing policy, service configuration data, or the like, employed by the network device when processing a service processed by the model.

Alternatively, if the first device is a server, the second device may be a terminal. In this case, the model calibration auxiliary information sent by the terminal to the server may include second auxiliary information determined by the network device, and may also include first auxiliary information determined by the terminal, and the like.

At step 204, the calibrated model is sent to the second device.

In the disclosure, the first device may obtain the calibrated model by performing calibration on the pre-trained model based on the model calibration auxiliary information after receiving the model calibration auxiliary information sent by the second device. Then, the first device may process relevant data based on the calibrated model.

Meanwhile, after the first device sends the calibrated model to the second device, the second device may process relevant service data based on the calibrated model.

In the disclosure, after obtaining the pre-trained model and the model calibration auxiliary information sent by the second device, the first device may obtain the calibrated model by performing calibration on the pre-trained model based on the model calibration auxiliary information, and send the calibrated model to the second device. In this way, by interaction between different devices, it is realized that the model is generated and configured flexibly, thus further improving the performance and efficiency of the communication system.

Referring to FIG. 3, FIG. 3 is a flow chart illustrating a method for generating a model according to an embodiment of the disclosure. The method is performed by a first device. The first device is a network device, and a second device is a terminal. As illustrated in FIG. 3, the method may include, but is not limited to, the following.

At step 301, a pre-trained model is generated by training.

In the disclosure, the network device may first generate the pre-trained model by performing training based on base training data.

The detailed implementation of step 301 may refer to detailed description of any embodiment of the disclosure, which is not limited herein.

At step 302, first auxiliary information determined by a terminal is received from the terminal.

Alternatively, the first auxiliary information of the terminal may include data for performing calibration on the pre-trained model, determined by the terminal, such that the calibrated model includes both training data of the network device (second auxiliary information) and the training data of the terminal (the first auxiliary information), and so on.

It should be noted that, models for processing different services may need different first auxiliary information when the models are calibrated. The terminal may report the first auxiliary information needed for model calibration to the network device as needed.

In addition, the first auxiliary information received by the network device may be first auxiliary information reported by one terminal after being determined by the terminal; or may be total first auxiliary information for performing calibration on the pre-trained model obtained by the network device merging multiple pieces of first auxiliary information reported by multiple terminals in the case that the multiple pieces of first auxiliary information determined by the multiple terminals are reported, which is not limited in the disclosure.

At step 303, a calibrated model is generated by performing calibration on the pre-trained model based on the first auxiliary information and second auxiliary information determined by a network device.

In the disclosure, the network device may perform calibration on the pre-trained model based on the first auxiliary information and the second auxiliary determined in local by the network device after receiving the first auxiliary information reported by the terminal.

At step 304, the calibrated model is sent to the terminal.

It should be noted that, since different terminals have different service capabilities, the network device may firstly determine a service which the calibrated model is configured to process after generating the calibrated model, and send the calibrated model to all terminals with a service capability of processing the service. Alternatively, the network device may send the calibrated model to multiple terminals with corresponding capabilities by means of a broadcast message or a system message, which is not limited in the disclosure. The detailed implementation of step 303 and step 304 may refer to detailed description of any embodiments of the disclosure, which is not limited herein.

In the disclosure, after the pre-trained model is generated and the first auxiliary information determined by the terminal is received from the terminal, the network device may obtain the calibrated model by performing calibration on the pre-trained model based on the first auxiliary information determined by the terminal and the second auxiliary information determined by network device in local, and send the calibrated model to the terminal. In this way, by interaction between the network device and the terminal, the flexible generation and configuration of the model is realized, thus further improving the performance and efficiency of the communication system.

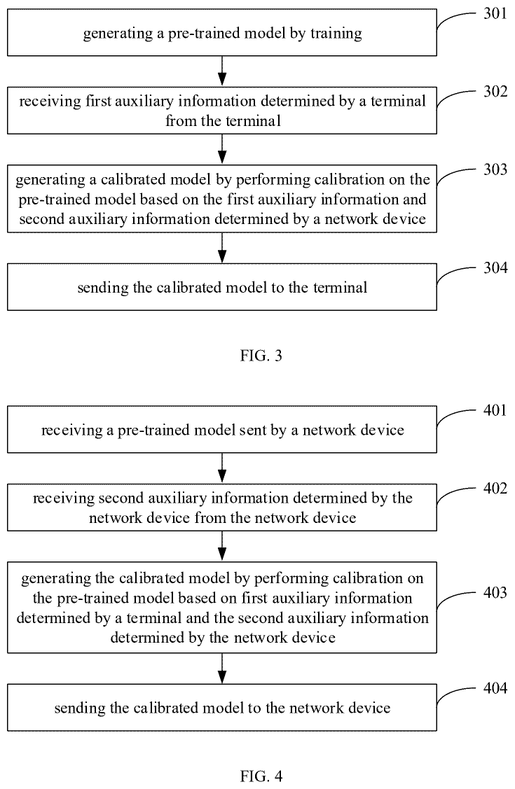

Referring to FIG. 4, FIG. 4 is a flow chart illustrating a method for generating a model according to an embodiment of the disclosure. The method is performed by a first device. The first device is a terminal, and a second device is a network device. As illustrated in FIG. 4, the method may include, but is not limited to, the following.

At step 401, a pre-trained model sent by the network device is received.

In the disclosure, after the network device generates the pre-trained model by performing training based on base training data, the network device may firstly send the pre-trained model to the terminal, such that the terminal generates a calibrated model by performing calibration on the pre-trained model.

At step 402, second auxiliary information determined by the network device is received from the network device The second auxiliary information determined by the network device may include a service identification, a processing policy, configuration data or the like in the network device side, which is not limited in the disclosure.

Alternatively, step 401 and step 402 may be performed simultaneously. For example, the network device sends the pre-trained model together with the second auxiliary information determined by the network device to the terminal by one message. Alternatively, step 402 may be performed before step 401. The above is not limited in the disclosure.

At step 403, the calibrated model is generated by performing calibration on the pre-trained model based on first auxiliary information determined by the terminal and the second auxiliary information determined by the network device.

At step 404, the calibrated model is sent to the network device.

The detailed implementation of step 403 and step 404 ma refer to detailed description about any embodiments of the disclosure, which is not limited herein.

In the disclosure, after the terminal sends the calibrated model to the network device, the network device may synchronize the calibrated model to another terminal with a service capability corresponding to the calibrated model, such that each terminal and the network device may process relevant service data based on the calibrated model.

In the disclosure, after the pre-trained model and the second auxiliary information determined by the network device from the network device are received, the terminal may update the pre-trained model based on the first auxiliary information determined by the terminal itself and the second auxiliary information determined by the network device, to obtain a model of the terminal itself, and report the model to the network device. In this way, by interaction between the network device and the terminal, the flexible generation and configuration of the model is realized, thus further improving the performance and efficiency of the communication system.

Referring to FIG. 5, FIG. 5 is a flow chart illustrating a method for generating a model according to an embodiment of the disclosure. The method is performed by a first device. The first device is a server, and a second device is a terminal. As illustrated in FIG. 4, the method may include, but is not limited to, the following.

At step 501, a pre-trained model is generated subjected to training.

In the disclosure, the server may firstly generate the pre-trained model by training based on base training data.

At step 502, first auxiliary information determined by the terminal and second auxiliary information determined by a network device is received from the terminal.

The second auxiliary information determined by the network device may be sent by the network device to the terminal, and may include a service processing policy and the like in the network device side, which is not limited herein in the disclosure.

Alternatively, step 501 and step 502 may be performed simultaneously. That is, the server may receive the first auxiliary information and the second auxiliary information determined by the network device from the terminal during training the pre-trained model. Alternatively, step 502 may be performed before step 501. The above is not limited in the disclosure.

At step 503, a calibrated model is generated by performing calibration on the pre-trained model based on the first auxiliary information and the second auxiliary information

At step 504, the calibrated model is sent to the terminal.

The detailed implementation of step 503 and step 504 may refer to detailed description of any embodiments of the disclosure, which is not limited herein.

It should be noted that, the server may send the calibrated model to multiple terminals, such that each terminal may process relevant service data based on the calibrated model.

In the disclosure, after the server generates the pre-trained model subjected to training and receives the second auxiliary information determined by the network device and the first auxiliary information determined by the terminal from the terminal, the server may update the pre-trained model based on the first auxiliary information and the second auxiliary to obtain a model of the server itself, and report the model to the terminal. In this way, by interaction of the server, the terminal and the network device, flexible generation and configuration of the model is realized, thus further improving the performance and efficiency of the communication system.

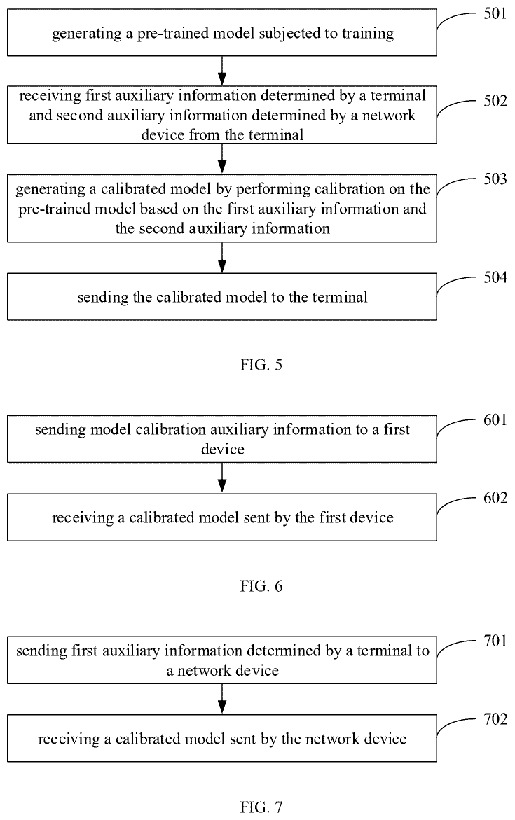

Referring to FIG. 6, FIG. 6 is a flow chart illustrating a method for generating a model according to an embodiment of the disclosure. The method is performed by a second device. As illustrated in FIG. 6, the method may include, but is not limited to, the following.

At step 601, model calibration auxiliary information is sent to the first device.

Alternatively, the first device may be a network device, a terminal, or a server, which is not limited in the disclosure.

Accordingly, if the first device is the network device, the second device may be the terminal. That is, after the network device generates a pre-trained model subjected to training, the terminal may send model calibration auxiliary information corresponding to the terminal itself, such as a bandwidth, a frequency band, etc., supported by the terminal, to the network device.

Alternatively, if the first device is the terminal, the second device may be the network device. In this case, the model calibration auxiliary information sent by the network device may be a processing strategy employed by the network device when processing a service of the terminal.

Alternatively, if the first device is the server, the second device may be the terminal. In this case, the model calibration auxiliary information sent by the terminal to the server may include model calibration auxiliary information of the network device, model calibration auxiliary information of the terminal, and etc.

At step 602, a calibrated model sent by the first device is received.

In the disclosure, after the second device sends the model calibration auxiliary information to the first device, the first device may generate the calibrated model by performing calibration on the pre-trained model based on the model calibration auxiliary information, and then send the generated model to the terminal.

In the disclosure, the second device sends the model calibration auxiliary information to the first device firstly, and then receives a model obtained by the first device based on the model calibration auxiliary information. In this way, by the interaction between the first device and the second device, flexible generation and configuration of the model is realized, further improving the performance and efficiency of the communication system.

Referring to FIG. 7, FIG. 7 is a flow chart illustrating a method for generating a model according to an embodiment of the disclosure. The method is performed by a second device. A first device is a network device, and the second device is a terminal. As illustrated in FIG. 7, the method may include, but is not limited to, the following.

At step 701, first auxiliary information determined by the terminal is sent to the network device.

The first auxiliary information of the terminal may include feedback information of the terminal side related to the model. For example, for a beam management model, the first auxiliary information may be feedback information of a beam and the like measured and determined by the terminal.

It should be noted that, models for processing different services may need different first auxiliary information when the models are calibrated. The terminal may report the first auxiliary information needed for model calibration to the network device as needed.

At step 702, a calibrated model sent by the network device is received.

In the disclosure, after the network device receives the first auxiliary information reported by the terminal, the network device may generate the calibrated model by performing calibration on the pre-trained model based on the first auxiliary information and second auxiliary information determined in local by the network device itself, and then send the calibrated model to the terminal.

In the disclosure, the terminal firstly sends the first auxiliary information to the network device, and then receives the calibrated model obtained by the network device performing calibration based on the first auxiliary information and the second auxiliary information determined by the network device. In this way, by interaction between the network device and the terminal, flexible generation and configuration of the model is realized, thus further improving the performance and efficiency of the communication system.

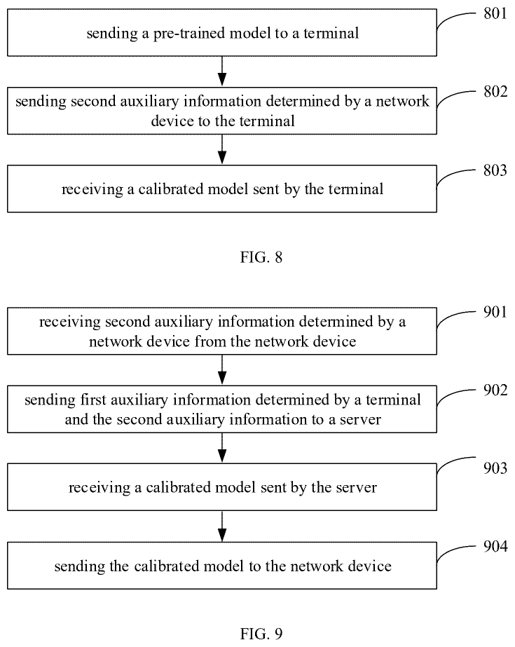

Referring to FIG. 8, FIG. 8 is a flow chart illustrating a method for generating a model according to an embodiment of the disclosure. The method is performed by a second device. A first device is a terminal, and the second device is a network device. As illustrated in FIG. 8, the method may include, but is not limited to, the following.

At step 801, a pre-trained model is sent to the terminal.

In the disclosure, after the network device generates the pre-trained model subjected to training, the network device may first send the pre-trained model to the terminal, and the terminal generates a model of the terminal by performing calibration on the pre-trained model.

In the disclosure, the network device may send the pre-trained model to one terminal, and the terminal performs calibration on the pre-trained model; or, the network device may send the pre-trained model to multiple terminals, and each terminal performs calibration on the pre-trained model independently, which is not limited herein in the disclosure.

At step 802, second auxiliary information determined by the network device is sent to the terminal.

The second auxiliary information determined by the network device includes a service identification, a service processing policy, service configuration data or the like of the network device, which is not limited in the disclosure.

Alternatively, step 801 and step 802 may be performed simultaneously. For example, the network device sends the pre-trained model together with the second auxiliary information determined by the network device to the terminal by one message. Alternatively, step 802 may be performed before step 801. The above is not limited in the disclosure.

At step 803, a calibrated model sent by the terminal is received.

In the disclosure, after the network device sends the pre-trained model and the second auxiliary information determined by the network device to the terminal, the terminal may generate the calibrated model by performing calibration on the pre-trained model based on the first auxiliary information of the terminal itself and the second auxiliary determined by the network device, and sends the calibrated model to the network device. Thus, the network device may perform data processing based on the calibrated model.

Alternatively, in the case that the network device sends the pre-trained model to one terminal, the network device may also synchronize the calibrated model to another terminal after receiving the calibrated model returned by the terminal, such that each terminal may process relevant service data based on the calibrated model.

Alternatively, in the case that the network device sends the pre-trained model to the multiple terminals, only one terminal may report the calibrated model based on a protocol agreement; or all terminals may report the calibrated model, but the network device merely stores a calibrated model first received, or the like, which is not limited in the disclosure.

In the disclosure, the network device first sends the pre-trained model and the second auxiliary information determined by the network device to the terminal, and then receives a model returned from the terminal. In this way, by interaction between the network device and the terminal, flexible generation and configuration of the model is realized, thus further improving the performance and efficiency of the communication system.

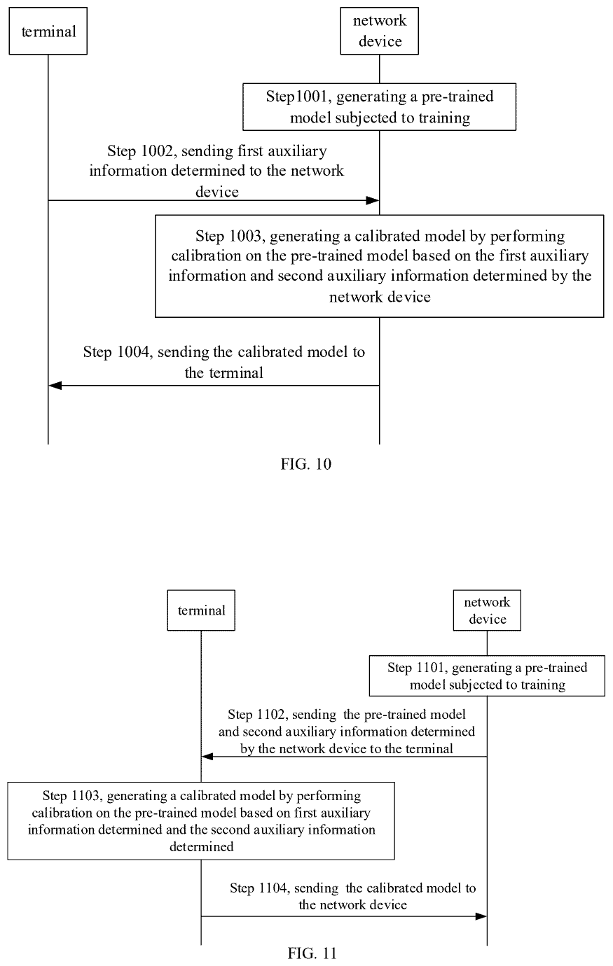

Referring to FIG. 9, FIG. 9 is a flow chart illustrating a method for generating a model according to an embodiment of the disclosure. The method is performed by a second device. The second device is a terminal, and a first device is a server. As illustrated in FIG. 9, the method may include, but is not limited to, the following.

At step 901, second auxiliary information determined by the network device is received from the network device.

At step 902, first auxiliary information determined by the terminal and the second auxiliary information are sent to the server.

At step 903, a calibrated model sent by the server is received.

At step 904, the calibrated model is sent to the network device.

In the disclosure, after the terminal sends the calibrated model to the network device, the network device may synchronize the calibrated model to another terminal. Thus, each terminal may process relevant service data based on the calibrated model.

In the disclosure, the terminal first receives the second auxiliary information determined by the network device from the network device, and sends the first auxiliary information of the terminal itself and the second auxiliary information to the server; and then may also send the calibrated model to the network device after receiving the calibrated model returned from the server. In this way, by interaction of the server, the terminal and the network device, flexible generation and configuration of the model is realized, thus further improving the performance and efficiency of the communication system.

Referring to FIG. 10, FIG. 10 is a schematic diagram illustrating a method for generating a model according to an embodiment of the disclosure. As illustrated in FIG. 10, the method may include the following.

At step 1001, a network device generates a pre-trained model subject to training.

At step 1002, a terminal sends first auxiliary information determined to the network device.

At step 1003, the network device generates a calibrated model by performing calibration on the pre-trained model based on the first auxiliary information and second auxiliary information determined by the network device.

At step 1004, the network device sends the calibrated model to the terminal.

In the disclosure, by interaction between the terminal and the network device, flexible generation and configuration of the model is realized, thus further improving the performance and efficiency of the communication system.

Referring to FIG. 11, FIG. 11 is a schematic diagram illustrating a method for generating a model according to an embodiment of the disclosure. As illustrated in FIG. 11, the method may include the following.

At step 1101, a network device generates a pre-trained model subjected to training.

At step 1102, the network device sends the pre-trained model and second auxiliary information determined by the network device to the terminal.

At step 1103, the terminal generates a calibrated model by performing calibration on the pre-trained model based on first auxiliary information determined and the second auxiliary information determined.

At step 1104, the terminal sends the calibrated model to the network device.

In the disclosure, by interaction between the terminal and the network device, flexible generation and configuration of the model is realized, thus further improving the performance and efficiency of the communication system.

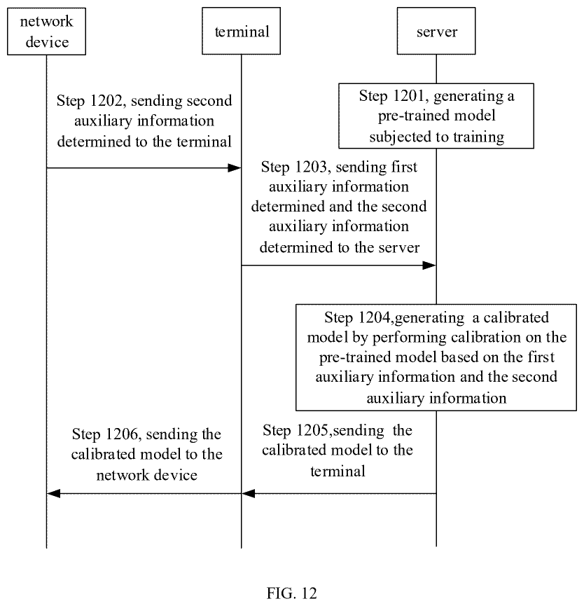

Referring to FIG. 12, FIG. 12 is a schematic diagram illustrating a method for generating a model according to an embodiment of the disclosure. As illustrated in FIG. 12, the method may include the following.

At step 1201, a server generates a pre-trained model subjected to training.

At step 1202, a network device sends second auxiliary information determined to a terminal.

At step 1203, the terminal sends first auxiliary information determined and the second auxiliary information determined to the server.

At step 1204, the server generates a calibrated model by performing calibration on the pre-trained model based on the first auxiliary information and the second auxiliary information.

At step 1205, the server sends the calibrated model to the terminal.

At step 1206, the terminal sends the calibrated model to the network device.

In the disclosure, by interaction of the server, the terminal and the network device, flexible generation and configuration of the model is realized, thus further improving the performance and efficiency of the communication system.

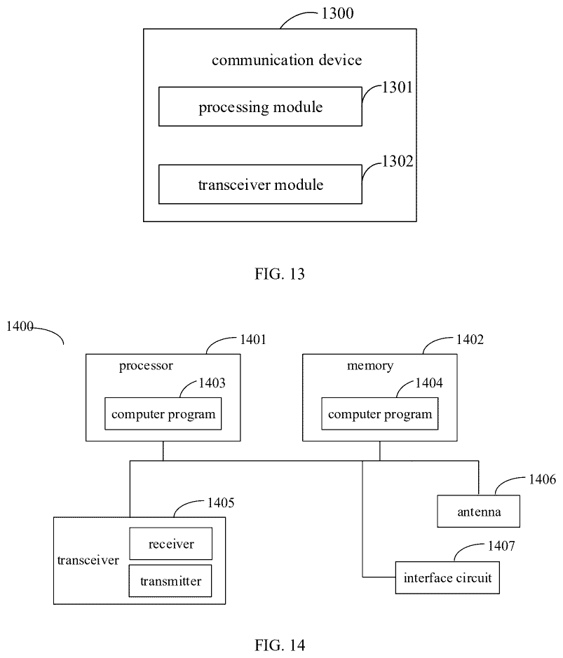

Referring to FIG. 13, FIG. 13 is a block diagram illustrating a communication device 1300 according to an embodiment of the disclosure. The communication device 1300 illustrated in FIG. 13 may include a processing module 1301 and a transceiver module 1302. The transceiver module 1302 may include a sending module and/or a receiving module. The sending module is configured to realize a sending function, and the receiving module is configured to realize a receiving function. The transceiver module 1302 may realize the sending function and/or the receiving function.

It may be understood that, the communication device 1300 may be a first device, an apparatus in the first device, or an apparatus that may be used in matching to the first device.

The communication device 1300 may be the first device.

The processing module 1301 is configured to obtain a pre-trained model; and The transceiver module 1302 is configured to receive model calibration auxiliary information sent by a second device.

The processing module 1301 is further configured to generate a calibrated model by performing calibration on the pre-trained model based on the model calibration auxiliary information.

The transceiver module 1302 is further configured to send the calibrated model to the device.

Alternatively, the first device is a network device, and the second device is the terminal. The transceiver module 1302 is further configured to receive first auxiliary information determined by the terminal from the terminal.

Alternatively, the first device is a terminal and the second device is a network device. The processing module 1301 is further configured to receive the pre-trained model sent by the network device.

Alternatively, the transceiver module 1302 is further configured to receive second auxiliary information determined by the network device from the network device.

Alternatively, the first device is a server, and the second device is a terminal. The transceiver module 1302 is further configured to:

receive first auxiliary information determined by the terminal and second auxiliary information determined by the network device from the terminal.

In the disclosure, after the first device obtains the pre-trained model and the model calibration auxiliary information sent by the second device, the first device may obtain a model by performing calibration on the pre-trained model based on the model calibration auxiliary information, and send a generated model to the second device. In this way, by the interaction between the first device and the second device, the flexible generation and configuration of the model is realized, thus further improving the performance and efficiency of the communication system.

It may be understood that, the communication device 1300 may be a second device, an apparatus in the second device, or an apparatus that may be used in matching to the second device.

The communication device 1300 may be the second device.

The transceiver module 1302 is configured to send model calibration auxiliary information to a first device.

The transceiver module is further configured to receive a calibrated model subjected to calibration based on the model calibration auxiliary information sent by the first device.

Alternatively, the first device is a network device, and the second device is a terminal. The transceiver module 1302 is further configured to

send first auxiliary information determined by the terminal to the network device.

Alternatively, the first device is a terminal and the second device is a network device. The transceiver module 1302 is further configured to send second auxiliary information determined by the network device to the terminal.

Alternatively, the transceiver module 1302 is further configured to send a pre-trained model to the terminal.

Alternatively, the first device is a server and the second device is a terminal. The transceiver module 1302 is further configured to:

send first auxiliary information determined by the terminal and associated second auxiliary information determined by a network device to the server.

Alternatively, the transceiver module 1302 is further configured to:

receive the second auxiliary information determined by the network device from the network device.

Alternatively, the transceiver module 1302 is further configured to:

send the calibrated model to the network device.

In the disclosure, the second device first sends the model calibration auxiliary information to the first device, and then receives a model obtained by the first device based on the model calibration auxiliary information. In this way, by interaction between the first device and the second device, the flexible generation and configuration of the model is realized, thus further improving the performance and efficiency of the communication system.

Referring to FIG. 14, FIG. 14 is a block diagram illustrating a communication device 1400 according to another embodiment of the disclosure. The communication device 1400 may be a first device, a second device, or a chip, a chip system or a processor that supports the first device to realize the above methods, or a chip, a chip system or a processor that supports the second device to realize the above methods. The communication device may be configured to realize the method described in the above method embodiments, and for details, please refer to the descriptions of the above method embodiments.

The communication device 1400 may include one or more processors 1401. The processor 1401 may be a general purpose processor or a dedicated processor, such as, a baseband processor or a central processor. The baseband processor is configured to process a communication protocol and communication data. The central processor is configured to control the communication device (e.g., a base station, a baseband chip, a terminal, a terminal chip, a central unit (CU) or a distributed unit (DU)), to execute a computer program, and to process data of the computer program.

Alternatively, the communication device 1400 may include one or more memories 1402 for storing a computer program 1404. The processor 1401 executes the computer program 1404 to cause the communication device 1400 to execute the method described in the above method embodiments. Alternatively, data may also be stored in the memory 1402. The communication device 1400 and the memory 1402 may be provided separately or may be integrated together.

Alternatively, the communication device 1400 may also include a transceiver 1405 and an antenna 1406. The transceiver 1405 may be referred to as a transceiver unit, a transceiver machine, or a transceiver circuit, for realizing a receiving and sending function. The transceiver 1405 may include a receiver and a transmitter. The receiver may be referred to as a receiver machine or a receiving circuit, for realizing a receiving function. The transmitter may be referred to as a sender machine or sending circuit, for realizing the sending function.

Alternatively, the communication device 1400 may also include one or more interface circuits 1407. The interface circuits 1407 are configured to receive code instructions and transmit the code instructions to the processor 1401. The processor 1401 runs the code instructions to cause the communication device 1400 to execute the method described in the method embodiments.

The communication device 1400 is a first device. The processor 1401 is configured to execute step 201 and step 203 in FIG. 2, step 301 and step 303 in FIG. 3, and etc. The transceiver 501 is configured to execute step 202 and step 204 in FIG. 2, step 302 and step 304 in FIG. 3, and etc.

The communication device 1400 is a second device. The transceiver 501 is configured to perform step 601 and step 602 in FIG. 6, step 701 and step 702 in FIG. 7, and etc.

In an implementation, the processor 1401 may include a transceiver for realizing the receiving and sending function. For example, the transceiver may be a transceiver circuit, an interface, or an interface circuit. The transceiver circuit, the interface, or the interface circuit for realizing the receiving and sending function may be separated, or may be integrated together. The transceiver circuit, the interface, or the interface circuit described above may be configured for code/data reading and writing, or may be configured for signal sending or delivery.

In an implementation, the processor 1401 may store the computer program 1403. The processor 1401 executes the computer program 1403 to cause the communication device 1400 to execute the methods described in the above method embodiments. The computer program 1403 may be solidified in the processor 1401, in which case the processor 1401 may be implemented by hardware.

In an implementation, the communication device 1400 may include a circuit. The circuit may implement the sending, receiving or communicating function in the above method embodiments. The processor and the transceiver described in the disclosure may be implemented in an integrated circuit (IC), an analog IC, a radio frequency integrated circuit (RFIC), a mixed signal IC, an application specific integrated circuit (ASIC), a printed circuit board (PCB), and an electronic device. The processor and transceiver may also be produced using various IC process technologies such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The communication device in the above description of embodiments may be the network device or a smart relay, but a scope of the communication device described in the disclosure is not limited thereto, and a structure of the communication device may not be limited by FIG. 14. The communication device may be a stand-alone device or may be a part of a larger device. For example the communication device may be:
(1) a stand-alone IC, a chip, a chip system or a subsystem;
(2) an IC collection including one or more ICs, where alternatively, the IC collection may also include storage components for storing data and a computer program;
(3) an ASIC, such as a modem;
(4) a module that may be embedded within other devices;
(5) a receiver, a terminal, a smart terminal, a cellular phone, a wireless device, a handheld machine, a mobile unit, an in-vehicle device, a network device, a cloud device, an artificial intelligence device, and the like; and
(6) others.

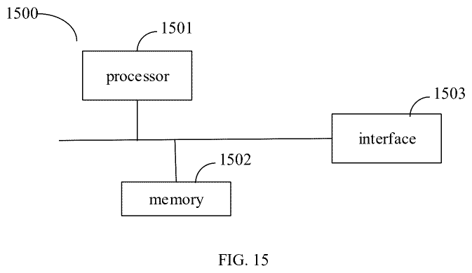

For the case where the communication device may be the chip or the chip system, please refer to the block diagram of the chip illustrated in FIG. 15. The chip illustrated in FIG. 15 includes a processor 1501 and an interface 1503. There may be one or more processors 1501, and there may be multiple interfaces 1503.

For the case where the chip is configured to realize the functions of the first device in the embodiments of the disclosure:

the interface 1503 is configured to execute step 202, step 204, etc., in FIG. 2.

For the case where the chip is configured to realize the functions of the second device in the embodiments of the disclosure:

the interface 1503 is configured to perform step 601, step 602, etc., in FIG. 6.

Alternatively, the chip further includes a memory 1502 for storing necessary computer programs and data.

It may be understood by those skilled in the art that various illustrative logical blocks and steps listed in embodiments of the disclosure may be realized by electronic hardware, computer software, or a combination of both. Whether such function is realized by hardware or software depends on a particular application and a design requirement of an entire system. Those skilled in the art may use various methods to realize the function for each particular application, but such implementation should not be construed as being beyond the scope of protection of embodiments of the disclosure.

The disclosure also provides a readable storage medium for storing instructions. When the instructions are executed by a computer, the function of any of the method embodiments described above is realized.

The disclosure also provides a computer program product. When the computer program product is executed by a computer, the function of any of the method embodiments described above is implemented.

The above embodiments may be implemented in whole or in part by software, hardware, firmware, or any combination of both; and when implemented using software, the above embodiments may be implemented in the form of the computer program product, in whole or in part. The computer program product includes one or more computer programs. When the computer program is loaded and executed in the computer, all or part of processes or functions described in embodiments of the disclosure is implemented. The computer may be a general-purpose computer, a dedicated computer, a computer network, or other programmable devices. The computer program may be stored in a computer-readable storage medium or transmitted from one computer-readable storage medium to another computer-readable storage medium. For example, the computer program may be transmitted from one web site, computer, server, or data center to another web site, computer, server, or data center, in a wired manner (e.g., by using coaxial cables, fiber optics, or digital subscriber lines (DSLs) or in a wireless manner (e.g., by using infrared wave, wireless wave, or microwave). The computer-readable storage medium may be any usable medium to which the computer has access to or a data storage device such as a server and a data center integrated by one or more usable mediums. The usable medium may be a magnetic medium (e.g., a floppy disk, a hard disk, and a tape), an optical medium (e.g., a high-density digital video disc (DVD)), or a semiconductor medium (e.g., a solid state disk (SSD)).

Those skilled in the art understands that the first, second, and other various numerical numbers involved in the disclosure are merely described for the convenience of differentiation, and are not used to limit the scope of the embodiments of the disclosure, but to indicate the order of precedence.

The term “at least one” in the disclosure may also be described as one or more, and the term “multiple” may be two, three, four, or more, which is not limited in the disclosure. In embodiments of the disclosure, for technical features, the terms “first”, “second”, and “third”; and “A”, “B”, “C” and “D” and the like are used to distinguish different technical features, the technical features described using the terms “first”, “second”, and “third”; and “A”, “B”, “C” and “D”; and the like do not indicate any order of precedence or magnitude.

The correspondences illustrated in the tables in the disclosure may be configured or may be predefined. The values of information in the tables are merely examples and may be configured to other values, which are not limited in the disclosure. In configuring the correspondence between the information and the parameters, there does not require that all the correspondences illustrated in the tables must be configured. For example, the above tables may be adjusted appropriately, such as splitting, merging, and the like. The names of the parameters illustrated in the headings of the above tables may be other names that are understood by the communication device, and the values or representations of the parameters may be other values or expressions that are understood by the communication device. Each of the above tables may also be implemented with other data structures, such as, arrays, queues, containers, stacks, linear tables, pointers, chained lists, trees, graphs, structures, classes, heaps, and hash tables.

The term “pre-definition” in the application may be understood as definition, pre-definition, storage, pre-storage, pre-negotiation, pre-configuration, curing, or pre-firing.

Those skilled in the art may know that the units and algorithmic steps of the various examples described in combination with the embodiments disclosed herein are capable of being realized in the form of the electronic hardware, or a combination of the computer software and the electronic hardware. Whether these functions are performed in the hardware or software way depends on the particular application and design constraints of the technical solution. Those skilled in the art may use different ways to implement the described functions for each particular application, but such implementations should not be considered as beyond the scope of the disclosure.

It is clearly understood by those skilled in the field that, for the convenience and brevity of description, detailed work processes of the systems, apparatuses, and units described above may be referred to the corresponding processes in the above method embodiments, which are not be repeated here.

The above is only detailed implementations of the disclosure, but the scope of protection of the disclosure is not limited thereto. Those skilled in the art familiar to the technical field may easily think of changes or substitutions in the technical scope disclosed by the disclosure, which shall be covered by the scope of protection of the disclosure. Therefore, the scope of protection of the disclosure shall be governed by the scope of protection of the appended claims.

1. A method for generating a model, performed by a first device, comprising:
obtaining a pre-trained model;
receiving model calibration auxiliary information sent by a second device;
generating a calibrated model by performing calibration on the pre-trained model based on the model calibration auxiliary information; and
sending the calibrated model to the second device.

2. The method of claim 1, wherein the first device is a network device and the second device is a terminal, and receiving the model calibration auxiliary information sent by the second device comprises:
receiving first auxiliary information determined by the terminal from the terminal.

3. The method of claim 1, wherein the first device is a terminal and the second device is a network device, and obtaining the pre-trained model comprises:
receiving the pre-trained model sent by the network device.

4. The method of claim 3, wherein receiving the model calibration auxiliary information sent by the second device comprises:
receiving second auxiliary information determined by the network device from the network device.

5. The method of claim 1, wherein the first device is a server and the second device is a terminal, and receiving the model calibration auxiliary information sent by the second device comprises:
receiving first auxiliary information determined by the terminal and second auxiliary information determined by a network device from the terminal.

6. A method for generating a model, performed by a second device, comprising:
sending model calibration auxiliary information to a first device; and
receiving a calibrated model subjected to calibration based on the model calibration auxiliary information, sent by the first device.

7. The method of claim 6, wherein the first device is a network device and the second device is a terminal, and sending the model calibration auxiliary information to the first device comprises:
sending first auxiliary information determined by the terminal to the network device.

8. The method of claim 6, wherein the first device is a terminal and the second device is a network device, and sending the model calibration auxiliary information to the first device comprises:
sending second auxiliary information determined by the network device to the terminal.

9. The method of claim 8, further comprising:
sending a pre-trained model to the terminal.

10. The method of claim 6, wherein the first device is a server and the second device is a terminal, and sending the model calibration auxiliary information to the first device comprises:
sending first auxiliary information determined by the terminal and second auxiliary information determined by a network device to the server.

11. The method of claim 10, further comprising:
receiving the second auxiliary information determined by the network device from the network device.

12. The method of claim 10, further comprising:
sending the calibrated model to the network device.

13. A first device, comprising:
a processor; and
a memory for storing a computer program executable by the processor,
wherein the processor is configured to:
obtain a pre-trained model; and
receive model calibration auxiliary information sent by a second device;
wherein the processor is further configured to generate a calibrated model by performing calibration on the pre-trained model based on the model calibration auxiliary information; and
the processor is further configured to send the calibrated model to the second device.

14. A second device, comprising:
a processor; and
a memory for storing a computer program executable by the processor,
wherein the processor is configured to execute the method of claim 6.

15-16. (canceled)

17. The first device of claim 13, wherein the processor is configured to:
receive first auxiliary information determined by the terminal from the terminal.

18. The first device of claim 13, wherein the processor is configured to:
receive the pre-trained model sent by the network device.

19. The first device of claim 18, wherein the processor is configured to:
receive second auxiliary information determined by the network device from the network device.

20. The first device of claim 13, wherein the processor is configured to:
receive first auxiliary information determined by the terminal and second auxiliary information determined by a network device from the terminal.
